(19) United States
(12) Patent Application Publication
(10) Pub. No.: US 2012/0145431 A1
(43) Pub. Date: Jun. 14, 2012

(54) CARBON NANOTUBE CONDUCTIVE FILM AND METHOD FOR MANUFACTURING SAME

(76) Inventors: Da Jeong Jeong, Suwon-si (KR); Yun Young Bang, Buk-gu (KR)

(21) Appl. No.: 13/265,629

(22) PCT Filed: Apr. 21, 2010
(86) PCT No.: PCT/KR2010/002480

§ 371 Date: Jan. 13, 2012

(30) Foreign Application Priority Data
Apr. 23, 2009 (KR) 10-2009-0035629
Apr. 23, 2009 (KR) 10-2009-0035631

(51) Int. Cl. H01B 7/17; H01B 13/06; H01B 13/00; B82Y 30/00

(52) U.S. Cl. 174/110 R; 427/122; 977/762

(57) ABSTRACT

A carbon nanotube conductive film and methods of manufacturing the same is disclosed. According to some exemplary embodiments, the carbon nanotube conductive layer includes a base layer, a carbon nanotube electrode layer, and a protective layer. The carbon nanotube electrode layer is formed on the base layer. The protective layer is formed on the carbon nanotube electrode layer and contains a ceramic binder to which a polarity reactor is combined in the side chain of a base framework which has hydrophobic reactors in the other side chains. The carbon nanotube transparent conductive film having increased durability without decreasing conductivity may be manufactured.

### TECHNICAL FIELD

Example embodiments relates to a carbon nanotube conductive film and methods of manufacturing the same, which are applicable to diverse areas including display apparatuses, current off preventing products, touch panels, and transparent heaters.

### BACKGROUND ART

Generally, transparent conductive films have high conductivity (for example, surface resistance of 1×10³ Ω/sq or less) and high transmission (80% or more) in a visible region. Thus, the transparent conductive films have been used as antistatic films of window glass of cars or buildings, transparent electronic wave shields such as electromagnetic shielding films, solar control layers, transparent heaters such as a freezing showcase or the like, as well as an electrode of a luminous element and a photodetector package on PDP (Plasma Display Panel), LCD (Liquid Crystal Display), LED (Light Emitting Diode), OLED (Organic Light Emitting Diode), touch panel, or solar cell. Recently, research on applying carbon nanotubes to an electrode to be coated on a base layer is being conducted.

The carbon nanotubes have only 0.04% theoretical percolation concentration, thus, the carbon nanotubes are evaluated to be an ideal material capable of embodying conductivity while retaining an optical property, and when a thin film of the carbon nanotubes is coated on a specific base layer in the unit of nanometer, light is transmitted in a visible region such that the carbon nanotubes exhibit transparency, retain an electric property which is an unique feature of the carbon nanotubes, and may be used as a transparent electrode.

A conductive film whose electrodes are carbon nanotubes is embodied by coating a carbon nanotube dispersion solution on a base layer, and coating methods thereof being actively utilized are a method of filtering and spreading a dispersion solution, a splay coating method, and a coating method using a mixed binder. The spray coating method is being more actively used since the method has advantages of being applicable to a large area and no need to mix carbon nanotubes (CNTs) with a binder. However, the spray coating method has a defect of getting scratches in a manufacturing process and weak environmental durability, because carbon nanotubes are exposed to the outside.

### DETAILED DESCRIPTION OF THE INVENTION

### Technical Goal of the Invention

The present inventive concept aims to provide a carbon nanotube conductive film which has excellent surface hardness, stability in high temperature and high humidity, chemical resistance, durability, as well as high conductivity.

According to an exemplary embodiment of the present inventive concept, a carbon nanotube conductive film including a base layer, a carbon nanotube electrode layer, and a protective layer, wherein the carbon nanotube electrode layer is formed on the base layer, and the protective layer is formed on the carbon nanotube electrode layer and contains a ceramic binder to which a polarity reactor is combined in the side chain of a framework which has hydrophobic reactors in the other side chains, is provided.

According to another exemplary embodiment of the present inventive concept, a carbon nanotube conductive film including a base layer, a carbon nanotube electrode layer, and a protective layer, wherein the protective layer is formed on the carbon nanotube electrode layer and contains a ceramic binder, is provided.

At this time, the protective layer is desired to be disposed such that polarity reactor thereof contacts a surface of the carbon nanotube electrode layer and a hydrophobic reactor thereof directs to the external surface.

The ceramic binder is desired to have an oxygen atom and be combined to a polar solvent with a hydrogen bond. At this time, the ceramic binder composing the protective layer has a structure of frame of [—Si(R1R2)—O—]n in which two alkyl groups are substituted for silicon (Si) and is desired to have a structure in which an alkyl substitution moiety and a moiety combining SI and two oxygen atoms direct to opposite directions with each other structurally.

According to another exemplary embodiment of the present inventive concept, a method of manufacturing a carbon nanotube conductive film including preparing a base layer, forming a carbon nanotube electrode layer by coating carbon nanotubes on the base layer, and coating a coating solution containing a ceramic binder having a hydrophobic reactor in the side chain and a polar solvent is provided.

According to yet another embodiment of the present inventive concept, a method of manufacturing a carbon nanotube conductive film including preparing a base layer, forming a carbon nanotube electrode layer by coating carbon nanotubes on the base layer, and forming a protective layer by coating ceramics having alkyl groups in the side chains on the carbon nanotube electrode layer is provided.

The coating a coating solution includes preparing a solvent to be bound to the oxygen atoms of the ceramic binder with a hydrogen bond, preparing a coating solution by mixing the ceramic binder containing a silicon binder having oxygen atoms with the solvent, and coating the coating solution on the carbon nanotube electrode layer.

According to still yet another embodiment of the present inventive concept, a method of manufacturing a carbon nanotube conductive film including preparing a base layer, forming a carbon nanotube electrode layer by coating carbon nanotubes on the base layer, and forming a protective layer by coating a mixed solution of carbon nanotubes and ceramics on the carbon nanotube electrode layer is provided.

### Effect of the Invention

According to the present inventive concept, a carbon nanotube conductive layer having high conductivity, and durability on high temperature, high humidity, and chemical stability is accomplished by coating a ceramic binder on the carbon nanotube layer.

### BRIEF DESCRIPTION OF THE DRAWINGS

The above and/or other features of the present general inventive concept will become apparent and more readily appreciated from the following description of the exemplary embodiments, taken in conjunction with the accompanying drawings, in which:

FIG. 1 is a sectional view illustrating a section of a carbon nanotube conductive film according to an exemplary embodiment of the present inventive concept;

FIG. 2 is a sectional view illustrating the enlarged view of part A in FIG. 1;

FIG. 3 is a sectional view illustrating an example of modification of FIG. 2;

FIG. 4 is a sectional view illustrating another example of modification of FIG. 2;

FIG. 5 is a diagram illustrating a structure of basic molecule arrangement of a protective layer;

FIG. 6 is a block diagram illustrating a method of manufacturing a carbon nanotube conductive film according to an exemplary embodiment of the present inventive concept;

FIG. 7 is a block diagram illustrating an example of modification of FIG. 6; and

FIG. 8 is a block diagram illustrating another example of modification of FIG. 6.

### MODE FOR CARRYING THE INVENTION

The attached drawings for illustrating preferred embodiments of the present invention are referred to in order to gain a sufficient understanding of the present invention, the merits thereof, and the objectives accomplished by the implementation of the present invention. It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Hereinafter, the present invention will be described in detail by explaining preferred embodiments of the invention with reference to the attached drawings. Like reference numerals in the drawings denote like elements.

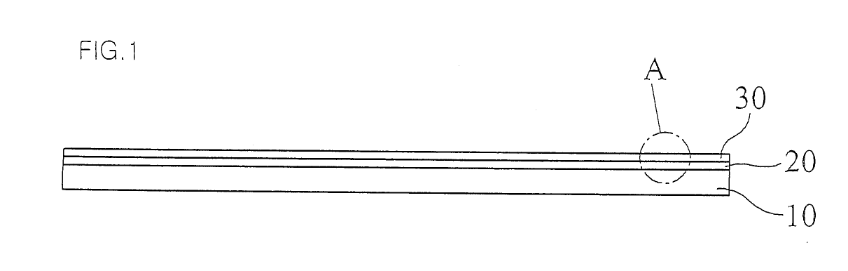

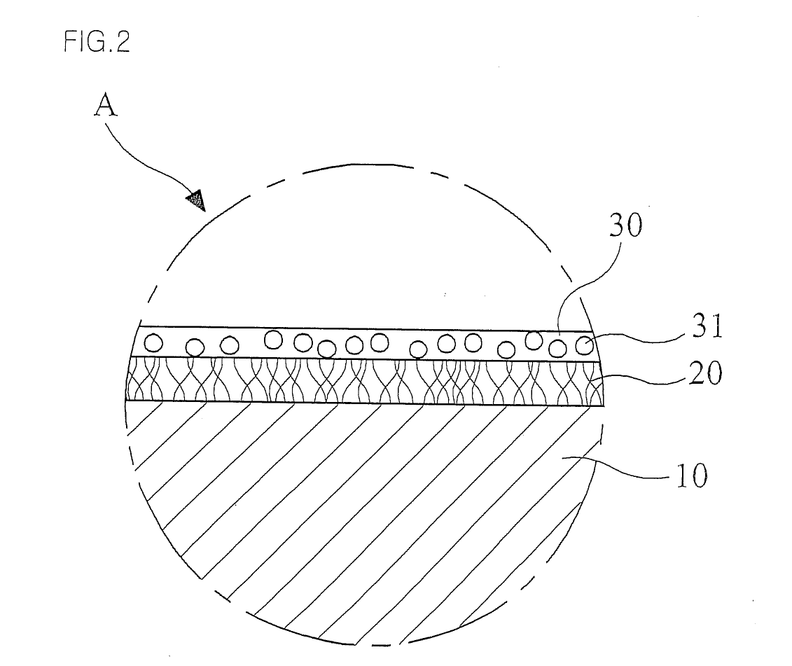

FIG. 1 is a sectional view illustrating a carbon nanotube conductive film according to an exemplary embodiment of the present inventive concept, and FIG. 2 is a sectional diagram of the enlarged view of part A in FIG. 1. As shown in FIGS. 1 and 2, a carbon nanotube conductive film 1 includes a base layer 10, a carbon nanotube electrode layer 20, and a protective later 30.

The carbon nanotube electrode layer 20 is formed on the base layer 10. The base layer 10 may be a transparent material, accordingly, may be made of glass, transparent polymer such as PET or the like, flit glass, or the like. At this time, the base layer 10 is desired to be made of a high transparent inorganic substrate or a transparent polymer substrate, thereby having flexibility.

The carbon nanotube electrode layer 20 includes carbon nanotubes. Carbon nanotubes (CNTs) have a tube form of carbon atoms combined with each other in a hexagon shape, and a diameter of the tube is extremely small as a level of nanometer, thereby having a unique electric chemical characteristic. When such carbon nanotubes are formed on a plastic or glass substrate to form a thin conductive layer, high transmission and high conductivity in a visible region may be achieved, thereby enabling to be used as a transparent electrode.

The protective layer 30 is formed on the carbon nanotube electrode layer and contains a ceramic binder 31. The protective layer 30 is configured to protect the carbon nanotube electrode layer 20 from outside, while not reducing transparency and electric conductivity of the collective film.

The protective layer 30 may be composed of the ceramic binders 31. Generally, ceramic binders 31 may be formed into a coating layer, which has high light transmission, has excellent adhesion thereby being easy to reinforce microcracks, heat resistance, fire resistance, and is useful when applied to coating.

The ceramic binders 31 may be a conductive material of SnO2, Y2O3 of high water repellent, MgO used as an electronic filter, SiO2 used as an adhesive, ZnO in sunscreen, and silicone according to the usage. The silicone binders among the above as an example of the ceramic binder 31 exhibit various properties of matter according to functional groups substituted for a silicon (SI) element. The functional groups may be converted into other functional groups through various chemical reactions, and an organic group such as methyl group, phenyl group, trifluorpropyl group, and, arkyl group may be substituted for the SI element, thus, silicone binders are widely used commercially. The ceramic binders 31 have an organic group combined to an inorganic backbone. For example, most of silicone molecules have a structure of a framework in the form of polysiloxane, [—Si(RR′)—O—]n. Silicone compounds have strong hydrophobic with low surface tensions, thus, may be used as a water repellent material without a separate reforming process.

The ceramic binder 31 according to an exemplary embodiment of the present inventive concept is desired to have a structure of [—Si(R1 R2)—O—]n framework in which two alkyl groups are substituted for Si. At this time, the alkyl groups are disposed so as to be face outward which is opposite to the surface of a carbon nanotube electrode layer exhibiting a hydrophobic characteristic when coated on the carbon nanotube electrode layer such that thermal resistance and humidity resistance may increase.

At this time, R1 is an alkyl group. And, R2 is an alkyl group or a high molecule. R2 in at least one side of a framework the ceramic binders is a high molecule. Other framework may be combined through the R2, thereby enabling multi-dimensional combination not one-dimensional combination.

For this, since a moity of two arkyl substitution [—R1—Si—R2—] and a moity of binding SI and oxygen atoms [—O—Si—O—] direct opposite directions with each other structurally, it is desirable to be disposed such that only hydrophobic alkyl groups direct outward effectively after being coated. At this time, R1 and R2 alkyl groups have an identical structure (R1═R2) which are branched from Si backbone symmetrically.

Accordingly, a solvent used for the coating may be alcohols, amine, distilled water, and general organic solvents, and the silicone binder may have a polyethylene oxide group in its terminal for having water solubility such that it may be collided in the solvent. The solvent is desired to have a boiling point of 120° C. or lower so that the solvent may be easily removed after the protective layer is coated on the carbon nanotube electrode layer.

The protective layer composed of the silicone compounds has excellent oxidation stability, high weather resistance, and low surface tension, contamination resistance, and excellent gas transmission.

Organic groups composing the protective layer 30 are easily mixed with carbon nanotubes and are maintained to be stable. Accordingly, the protective layer 30 has contact stability with carbon nanotube electdrode layer on its surface.

At this time, the protective layer 30 is desired to have thickness of a several to several hundreds nanometer unit so that conductivity of the carbon nanotube electrode layer may be maintained. Generally, binders may not have high conductivity. The silicone binders neither have surface resistance of 1 kΩ/sq or less which is equal value to the requirement fo a transparent electrode. To solve the problem, a thin ceramic coating layer with the unit of nano is formed on the carbon nanotubes so that an electrode characteristic of the below carbon nanotube electrode layer may not be degenerated as much as possible. Preferrably, the ratio of the thickness of the protective layer to the thickness of the carbon nanotube electrode layer may be adjusted to be 2 or less.

In addition, when a functional group combined to the ceramic binder is selected properly, flexibility of the carbon nanotube conductive layer may be retained. For example, the ceramic binder may retain coatability on a flexible coating surface by selecting at least one of alkyl groups in the side chains. At this time, the number of carbons of the alkyl group in the side chain is desired to be from 5 to 15. And, the concentration of the ceramic binder is desired to be solid content 20 wt % or less.

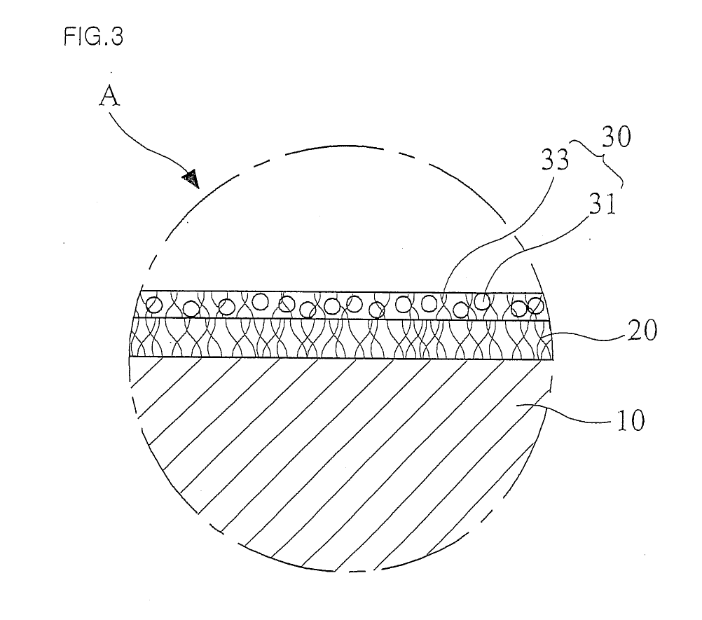

Meanwhile, as shown in FIG. 3, the protective layer 30 may be composed of a mixture of a ceramic binder 31 and carbon nanotubes 33 such that conductivity of a carbon nanotube electrode layer 20 may be retained. That is, a coating solution in which a ceramic binder 31 and carbon nanotubes 33 are mixed with a predetermined ratio is coated on the carbon nanotube electrode layer, so that, surface resistance caused by the coating the protective layer may not increase and an electrode characteristic of the carbon nanotubes may be retained.

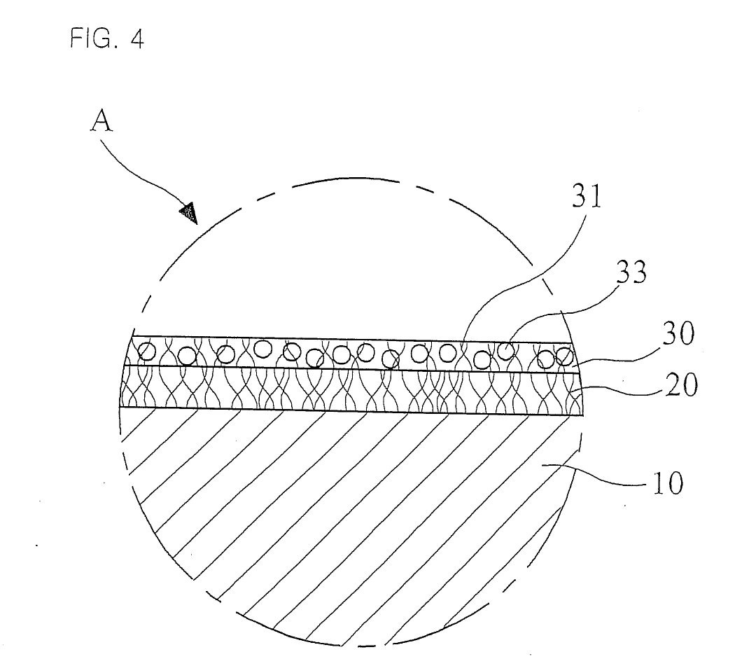

Referring to FIG. 4, a ceramic binder 31 may have a hydrophobic reactor in the side chain, and at the same time, a protective layer may contain a polarity solvent 33, according to an exemplary embodiment of the present invention. When a silicone binder is coated on a carbon nanotube electrode layer along with the polarity solvent, the silicone binder may retain general binder property, a hydrophobic characteristic after thin layer coating, and adhesion stability, and conductivity of the carbon nanotube electrode layer may be retained.

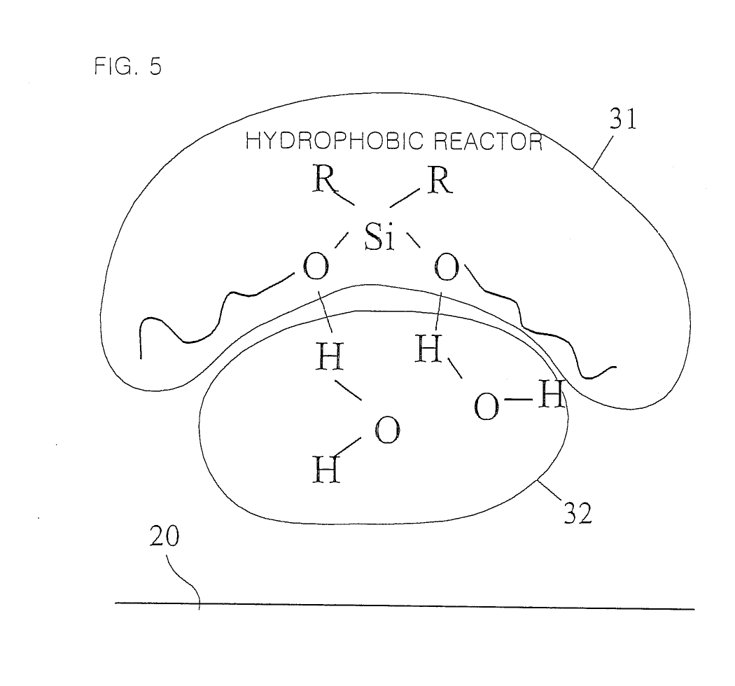

FIG. 5 is a diagram illustrating an example of a structure of the protective layer of the present invention. Referring to FIG. 5, the silicone binder has a structure of framework of [—Si(R1R2)—O—]n in which two alkyl groups are substituted for SI and its solvent may be a solvent of water affiliation. At this time, the alkyl groups are disposed so as to direct outward not to the surface of carbon nanotube electrode layer exhibiting a hydrophobic characteristic when coated on the surface of the carbon nanotube electrode layer, so that durability of the electrode in high temperature and high humidity may increase.

For this, since a moity of two arkyl substitution, [—R1—Si—R2], and a moity of binding SI and two oxygen atoms, [—O—Si—O—], direct opposite directions with each other structurally, it is desirable to be disposed such that only the hydrophobic alkyl groups direct outward effectively after being coated. At this time, R1 and R2 alkyl groups have an identical structure (R1=R2) which are branched from Si backbone symmetrically.

In addition to the above, a specific solvent enabling to utilize a structural characteristic of the silicone needs to be used such that hydrophobic reactors (alkyl groups) are applied on the top surface of the electrode and side chains of the silicone compounds are bound to the carbon nanotube layer, which inducing maximizing adhesion stability with respect to the electrodes.

For this, a polarity solvent 32 enabling hydrogen bond to oxygen atoms existing in the framework of silicone compounds may be used as a solvent to form a protective layer. Generally, since alkyl groups have non-polarity, they direct to the opposite direction of the solvent molecules in the polarity solvent, and the polarity solvent induces the side chains of the binder to direct downward, that is, to the carbon nanotube electrode layer, through hydrogen bond with oxygen atoms of the silicone. Especially, when multilayers of the solvent are formed on the carbon nanotube electrode layer in the unit of nano, alkyl groups are disposed to the opposite direction from the surface to which the solvent is applied, accordingly, akyl groups may be disposed on the exterior surface of the protective layer.

Accordingly, the solvent used for the coating may be a polarity solvent capable of hydrogen bond such as alcohols, amine, distilled water, and the like, and the silicone binder has a polyethylene oxide group in its terminal for having water solubility such that the binder may be collided in the solvent. The polarity solvent is desired to have a boiling point of 120° C. or lower so that the solvent may be easily removed after the protective layer is coated on the carbon nanotube electrode layer.

The protective layer composed of the ceramic compounds has excellent oxidation stability, high weather resistance, and low surface tension, contamination resistance, and excellent gas transmission.

Organic groups of the ceramics are easily mixed with carbon nanotubes and are maintained to be stable. Accordingly, the protective layer has contact stability with carbon nanotube electrode layer on its surface.

In addition, when a functional group combined to the ceramic binder is selected properly, flexibility of the carbon nanotube conductive layer may be retained. For example, the ceramic binder may retain coatability on a flexible coating surface by selecting at least one of alkyl groups in the side chains. At this time, the number of carbons of the alkyl group in the side chain is desired to be from 5 to 15. And, the concentration of the ceramic binder is desired to be solid content 20 wt % or less.

The protective layer 30 further may further include carbon nanotubes 33 such that conductivity of the carbon nanotube electrode layer 20 may be retained. That is, a coating solution in which a ceramic binder 31, carbon nanotubes 33, and a polarity solvent 32 are mixed with a predetermined ratio is coated on the carbon nanotube electrode layer, so that surface resistance caused by the coating the protective layer may not increase and an electrode characteristic of the carbon nanotube may be retained.

With a SEM image of partial culling of the protective layer of a carbon nanotube conductive film, it can be shown that the protective layer 30 is protecting the carbon nanotube electrode layer 20.

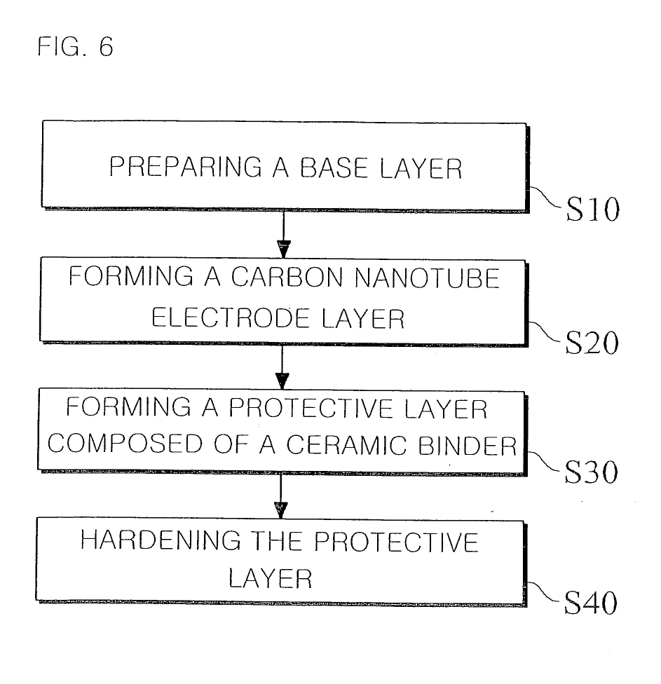

FIG. 6 is a block diagram illustrating a method of manufacturing a carbon nanotube conductive film according to an exemplary embodiment of the present invention. As shown in FIG. 6, the method of manufacturing a carbon nanotube conductive film includes a step of preparing a base layer S10 at first. The base layer may be glass or flexible polymer as already described.

Next step is forming a carbon nanotubes electrode layer by coating carbon nanotubes on the base layer S20. At this time, the carbon nanotubes may be single-walled nanotube or multi-walled nanotube. A method of coating carbon nanotubes may be a spray coating method, a method of filtering and spreading a dispersion solution, and a coating method using binders.

Thereafter, the method includes a step of forming a protective layer by coating a ceramic binder which has alkyl groups in the side chains on the carbon nanotubes electrode layer S30. The step S30 includes diluting the ceramic binder at first. At this time, the diluting solution uses water and alcohol affiliation solvent and dilutes the ceramic binder such that the amount of binder comparing to the weight of coating solution for protective layer is 10 wt % or less. The diluted coating solution is coated on the carbon nanotubes electrode layer. At this time, thickness of the coating is adjusted such that stability and conductivity of the carbon nanotube electrode layer surface may be retained, preferrably, it is desired to be adjusted in a range that surface resistance is changed compared to initial surface resistance by 50% or lower. A method of coating the diluted coating solution for the protective layer may be a general coating method such as spray coating, gravure, spin coating, roll coating, and the like.

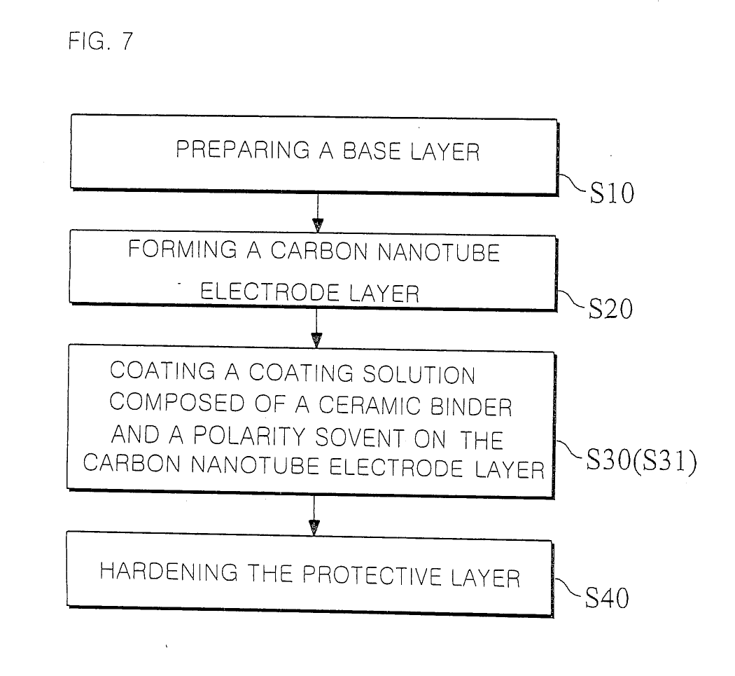

In this case, the ceramic binder may include a polarity solvent (S31) in the step of forming the protective layer as shown in FIG. 7. At this time, the ceramic binder may be a binder having a silicone backbone. The silicone binder has two identical alkyl groups in the side chains for hydrophobic, and the number of carbon in the alkyl group is preferred to be from 5 to 15. The silicone binder has a polyethylene oxide group in its terminal for having water solubility such that it may be collided in the solvent.

The solvent may be a polarity solvent capable of hydrogen bond with silicon binder, for example, alcohols, amine, and distilled water, and they may be used solely or with a mixed solvent. The solvent is desired to have a boiling point of 120° C. or lower so that the solvent may be easily removed after the protective layer is coated on the carbon nanotube electrode layer.

Thickness of the coating is adjusted such that stability and conductivity of the carbon nanotube electrode layer surface may be retained, preferrably, it is desired to be adjusted in a range that surface resistance is changed compared to initial surface resistance by 50% or lower. A method of coating the diluted coating solution for the protective layer may be a general coating method such as spray coating, gravure, spin coating, roll coating, and the like.

After the step of coating a coating solution for the protective layer, hardening the coating solution is performed S40. For this, a warm-up time is necessary for approximately 1 hour at a pretreatment temperature of 40-60° C., and thereafter, complete hardening for 60 minutes at 100-150° C., more preferably, at 125-135° C. is carried out. The temperature and the time for the heating process may be adjusted according to a kind of the substrate and a characteristic of the binder.

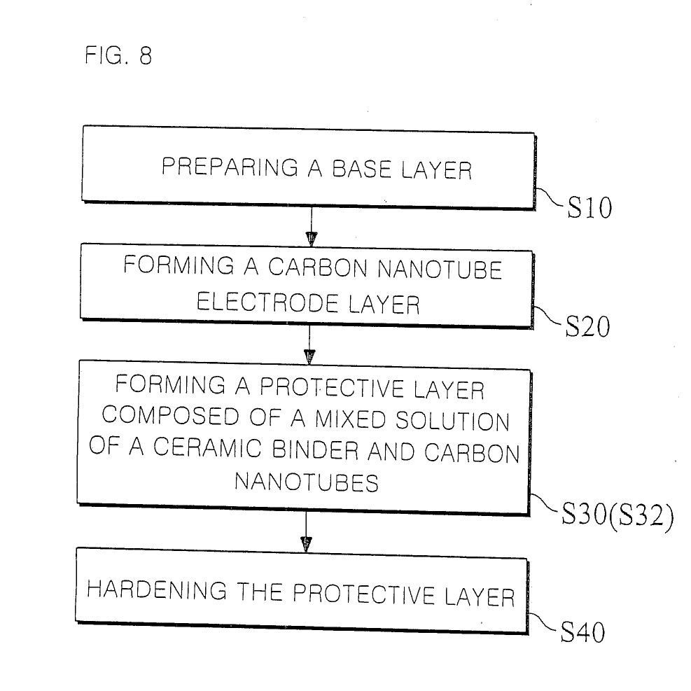

Meanwhile, as shown in FIG. 8, the protective layer may include carbon nanotubes. In other words, the protective layer includes a mixture of ceramic binder and carbon nanotubes in the step of coating the protective layer on the carbon nanotube electrode layer S32. For this, a mixed solution may be prepared by mixing a ceramic binder to a carbon nanotube dispersion solution and the mixed solution may be coated on the carbon nanotube electrode layer. If concentration of the carbon nanotube dispersion solution is high, transmission of a transparent electrode may be drastically degenerated, and if concentration is low, conductivity of a film after top coating may fall.

The coating method may be a general coating method such as spray coating, gravue coating, spin coating, roll coating, or the like. Thickness of the coating is preferred to be 10-500 nm, and if the thickness is 500 nm or more, light transmission may be degenerated, and if the thickness is 10 nm or less, durability may be degenerated.

When a mixed coating solution in which carbon nanotube dispersion solution and a silicone binder are mixed is used, bundles of carbon nanotubes in the protective layer and bundles of existing carbon nanotube thin layer get tangled, which results in improving adhesion of coating agents. Such improvement of adhesion generates a feature of conductive film that improves stability of thin film more after coating better than in a coating method of conductive particles such as gold and silver being applied to the inside of generally used conductive adhesives.

### EXAMPLES

A silicone binder is coated on a base layer on which carbon nanotube electrode layer is deposited as a protective layer, and distilled water is used as a polarity solvent in Exemplary embodiment 1.

A mixed solution of a silicone binder and carbon nanotubes is coated on a base layer on which carbon nanotube electrode layer is deposited as a protective layer in Exemplary embodiment 2.

A carbon nanotube electrode layer is deposited on a base layer, and a protective layer is not coated separately in Comparison example 1.

A carbon nanotube electrode layer is deposited on a base layer, and hexan is used as a solvent in Comparison example 2.

A test for confirming durability in high temperature and high humidity of the transparent electrodes formed as such was conducted. A constant temperature and humidity chamber was used to maintain the test condition of 65° C., 95%, 240 hours.

A result of confirming durability by measuring a change of surface resistance value before and after the test is stable such that an initial value of surface resistance (R0) was 600 Ω/sq, and after testing in the condition of 65° C., 95%, 240 hours, the value has changed into 620 Ω/sq, which makes the ratio of change R/R0=1.03.

In the Exemplary embodiment 2, a result is stable such that an initial value of surface resistance (R0) was 550 Ω/sq, and after testing in the condition of 65° C., 95%, 240 hours, the value has changed into 550 Ω/sq, which makes the ratio of change R/R0=1.

In the Comparison example 1, a result is unstable such that an initial value of surface resistance (R0) was 500 Ω/sq, which denotes conductivity is high, and after testing in the condition of 65° C., 95%, 240 hours, the value has changed into 1000 Ω/sq, which makes the ratio of change R/R0=2.

As a result, when a silicone binder are used for a protective layer, comparing to the case of not using a protective layer, it has a defect of high surface resistance initially, but after testing in high temperature and high humidity, the surface resistance was nearly maintained consistently, which denotes to be stable. Unlike this, the surface resistance became higher drastically after testing in case of the Comparison example 1, which denotes to be unstable.

In the Comparison example 2, a result is unstable such that an initial value of surface resistance (R0) was 600 Ω/sq, and after testing in the condition of 65° C., 95%, 240 hours, the value has changed into 850 Ω/sq, which makes the ratio of change R/R0=1.4. That is, the ratio of change was greater that the ratio of change of 1.2% which is equal to the requirement for a general transparent electrode, and it is unstable in high temperature and high humidity.

While the present invention has been particularly shown and described with reference to exemplary embodiments thereof, it will be understood that various changes in form and details may be made therein without departing from the spirit and scope of the following claims.

### INDUSTRIAL APPLICABILITY

A carbon nanotube conductive film having high conductivity, and durability on high temperature, high humidity, and chemical stability is accomplished by coating a ceramic binder on the carbon nanotube layer.

1. A carbon nanotube conductive film comprising:
a base layer;
a carbon nanotube electrode layer formed on the base layer; and
a protective layer which is formed on the carbon nanotube electrode layer and contains a ceramic binder.

2. (canceled)

3. The carbon nanotube conductive film of claim 1,
a polarity reactor is combined to a basic framework which has at least one hydrophobic reactors in the side chain.

4. The carbon nanotube conductive film of claim 3, wherein a polarity reactor of the protective layer is disposed so as to contact a surface of the carbon nanotube electrode layer, and a hydrophobic reactors thereof are disposed so as to direct outward.

5. The carbon nanotube conductive film of claim 3, wherein the ceramic binder has oxygen atoms and the polarity reactor combined in the side chain of a basic framework of the ceramic binder is composed through hydrogen bond between the oxygen of the ceramic binder and a polarity solvent.

6. The carbon nanotube conductive film of claim 1, wherein the ceramic binder composing the protective layer has a structure of [—Si(R1R2)—O—]n framework in which two alkyl groups are substituted for Si, and a moiety of two alkyl substitution, and a moiety of binding Si and two oxygen atoms, direct to the opposite direction with each other structurally.

7. The carbon nanotube conductive film of claim 6, wherein the number of carbons of the alkyl group contained in the ceramic binder is from 5 to 15.

8. The carbon nanotube conductive film of claim 1, wherein ceramics composing the protective layer have a framework of selected one among SnO2, Y2O3, MgO, SiO2, ZnO, and silicone, and concentration of the protective layer is solid content 20 wt % or less.

9. The carbon nanotube conductive film of claim 1, wherein thickness of the protective layer is 10-500 nm.

10. The carbon nanotube conductive film of claim 1, wherein the ratio of thickness of the protective layer to thickness of the carbon nanotube electrode layer is 2 or less.

11. The carbon nanotube conductive film of claim 1, wherein the ratio of change of a surface resistance value after testing in the condition of 65° C., 95%, 240-hours as a reference of an initial surface resistance value is 1.2 or less.

12. A method of manufacturing a carbon nanotube conductive film comprising:
preparing a base layer;
forming a carbon nanotube electrode layer by coating carbon nanotubes on the base layer; and
forming a protective layer by coating a ceramic binder having hydrophobic reactors in the side chains and containing a polarity solvent on the carbon nanotube electrode layer.

13. (canceled)

14. The method of manufacturing a carbon nanotube conductive film of claim 12, wherein the ceramics have at least one of alkyl groups in the side chains, and the number of carbons of the alkyl group from 5 to 15.

15. The method of manufacturing a carbon nanotube conductive film of claim 12, wherein the coating the coating solution comprising:
preparing a solvent to be combined to the oxygen of the ceramic binder through hydrogen bond;
preparing a coating solution by mixing the ceramic binder composed of silicone binder with the solution; and
coating the coating solution on the carbon nanotube electrode layer.

16. The method of manufacturing a carbon nanotube conductive film of claim 15, wherein the silicone binder has a structure of [—Si(R1R2)—O—]n framework in which two alkyl groups are substituted for Si, and the coating solution in which a moiety the two alkyl substitution and a moiety binding Si and two oxygen atoms direct to the opposite directions with each other structurally.

17. The method of manufacturing a carbon nanotube conductive film of claim 15, wherein the forming a protective layer on the carbon nanotube electrode layer includes diluting the ceramics into the coating solution having a polarity solvent of water and alcohol affiliation with the amount of 10 wt % comparing to the weight of the coating solution and coating the diluted solution on the carbon nanotube electrode layer.

18. The method of manufacturing a carbon nanotube conductive film of claim 12, wherein the ceramic binder is mixed with carbon nanotubes.

19. The method of manufacturing a carbon nanotube conductive film of claim 12, wherein the method further comprising after the coating the coating solution:
performing a pretreatment of hardening with warming up at 40-60° C. temperature; and
performing a complete hardening the coating solution at 100-160° C. temperature.

20. A method of manufacturing a carbon nanotube conductive film comprising:
preparing a base layer;
forming a carbon nanotube electrode layer by coating carbon nanotubes on the base layer; and
forming a protective layer by coating a mixed coating solution of carbon nanotubes and ceramics on the carbon nanotube electrode layer.

21. (canceled)

22. The method of manufacturing a carbon nanotube conductive film of claim 20, wherein the forming the protective layer on the carbon nanotube electrode layer includes diluting the ceramics into the coating solution having a polarity solvent of water and alcohol affiliation with the amount of 10 wt % comparing to the weight of the coating solution and coating the diluted solution on the carbon nanotube electrode layer.

23. The method of manufacturing a carbon nanotube conductive film of claim 20, the method further comprising after forming the protective layer:
performing a pretreatment of hardening with warming up at 40-60° C. temperature; and
performing a complete hardening the coating solution at 100-160° C. temperature.
